(19) United States
(12) Patent Application Publication
(10) Pub. No.: US 2007/0196582 A1
(43) Pub. Date: Aug. 23, 2007

(54) Protective aqueous treatment for wood and method for producing treatment

(75) Inventors: John Sinko, Mequon, WI (US); Donghong Li, Wausau, WI (US); Darryl L. Cielinski, Wausau, WI (US); John A. Hennes, Milwaukee, WI (US)

Correspondence Address: RYAN KROMHOLZ & MANION, S.C., POST OFFICE BOX 26618, MILWAUKEE, WI, 53226, US

(73) Assignees: Wayne Pigment Corp.; Hoffer's Coatings, Inc.

(21) Appl. No.: 11/359,019

(22) Filed: Feb. 22, 2006

(51) Int. Cl. B05D 3/02; C09D 5/14; C09D 5/16

(52) U.S. Cl. 427/397; 427/393; 427/372.2; 106/15.05; 106/18.32; 106/18.33; 106/18.34; 106/18.36

(57) ABSTRACT

A multi-functional aqueous protective treatment for wood substrates. The treatment comprises an aqueous solution of a zirconyl compound and incorporated bio-active constituents, providing protection against bio-degradation of wood and against degradation of aesthetic value of applied wood coatings by spontaneous staining and also protects against termites or other “in-depth” bio-degradation factors.

### RELATED APPLICATIONS

This application claims the benefit of co-pending Provisional Patent Application Ser. No. 60/653,137, filed 22 Feb. 2005.

### BACKGROUND OF THE INVENTION

The present invention relates to compositions and processes for treating wood substrates and, more specifically, compositions and processes for protective treatment of wood against bio-environmental degradation factors. Structurally, wood can be regarded as a hydrophilic bio-composite of fibrous cellulose and resinous lignins, and also containing substantial void volumes. As a result, wood, a renewable and biodegradable material, is vulnerable to environmental degradation factors and processes, which include both physical and micro-biological concerns. Physical factors that contribute to degradation of wood include: UV radiation, seasonal temperature variations, humidity or condensed water. Wood possesses high degree of affinity for water and is in a dynamic equilibrium with air humidity, resulting also in dimensional instability. That is, depending on the relative humidity of the surrounding environment and atmosphere, wood will shrink or swell, one of the physical factors which promote degradation of wood. The micro-biological, or bio-environmental factors that contribute to the deterioration of wood include fungi, mildew, algae, bacteria and, specifically, termites.

Various protective technologies exist that are intended to slow the rate of the degradation of wood. It will be apparent that protective technologies have important economical impact, especially concerning high priced items of wood of aesthetic and/or practical value.

Currently, organic coatings, in addition to their intended function of enhancing the aesthetic value of wood, also represent the most versatile surface protective technology of wood and usually are formulated to resist against environmental degradation factors, both physical and biological. However, organic coatings do have significant limitations including: vulnerability to tannin staining (which results in degradation of their aesthetic value) and perhaps, more importantly, the inability to provide any “in depth” protection of wood substrates, such as necessary against termites. That is, protective organic coatings are not necessarily efficient at protecting the entire mass of the wood substrate, most notably the inner structure of wood substrates. It will be apparent that while other micro-biological destructive factors, such as fungus, mildew, bacteria and algae operate on the surface, termites attack through and consume the entire mass (depth) of wood substrates. Evidently, it would be desirable if, in addition to surface protection, protective coatings would provide “in depth” protection for wood, as well.

The state of art of technologies intended for “in depth” protection of wood against biological degradation factors are based on liquid formulations of various biocides dissolved usually in diverse organic solvents. In practice, “in depth” protection is realized by immersion of wood into such organic liquid formulations followed by drying and usually, by subsequent application of protective organic coatings.

As known in the industry, immersion in organic solvents and, more specifically, drying of such treated wood, are very time intensive operations and, consequently, most “in depth” protective technologies for wood generally are characterized by low productivity, which further results in significant release of organic solvents into the atmosphere.

Notable, some commercial formulations also contain dissolved wax constituents intended to provide hydrophobe character to wood surfaces. An undesirable consequence of this is however, that wood substrates with such altered surface character are less suitable for subsequent application of water-borne coatings.

Water-based formulations intended for “in depth” protection of wood against destructive bio-factors have been also introduced relatively recently on the market. While water is an excellent carrier medium, evidently it does not possess any capacity to immobilize usually leacheable bio-active components “in situ” of treated wood substrates.

These are considerable shortcomings of the art, both economically and environmentally. Likewise, these current technologies are intended exclusively for “in depth” protection of wood substrates, and do not possess any capacity to protect subsequently applied organic coatings against tannin staining.

Tannin staining is a spontaneous, cumulative, moisture driven process, resulting in degradation of aesthetic value of organic coatings, and in radical cases, in limited service life of coatings. The consequence of wood's affinity for water, tannin staining is caused by water-soluble extractables (tannins), and is more prevalent with water born organic coatings.

There are specialized stain inhibitor technologies known to the art, the most effective among them are the aqueous pretreatments for wood based on water soluble zirconyl compounds. As disclosed in U.S. Pat. Nos. 5,759,705 and 5,733,666, aqueous tannin stain inhibitor pretreatments are directly applied onto a wood substrate and allowed to absorb into the substrate. Subsequently, the pretreated substrates are dried, after which a primer coating is usually applied as an overcoat. With these surface treatment processes, the surface characteristics and texture of wood substrates are generally unaltered, while significantly reducing tannin staining activity. As the result, subsequent organic coating applications are compatible and are effectively protected against tannin staining (by the substrate) during their service life, and, more specifically, at the start of it, that is, during the process of film formation. It will be apparent that inhibition of tannin staining results in extended service life of wood coatings. It will be also apparent, however, that generally, aqueous pretreatments based on zirconyl salts are not intended for and do not provide any surface or “in depth” protection of wood against biological destructive factors.

Notable however, the above cited U.S. Pat. Nos. 5,759,705 and 5,733,666 also disclose the concept of an aqueous pretreatment that provides dual surface protective functions for wood. That is, this pretreatment inhibits tannin staining (of subsequently applied organic coatings) and provides surface protection against fungal or mildew attack on treated wood surfaces. As disclosed in these patents, in practice a dual protective function aqueous pretreatment for wood can be obtained by addition of an effective amount of a biocide-active quaternary ammonium compound into aqueous solution of zirconyl acetate.

While these treatments have been found generally effective in protecting wood surfaces, an aqueous multi-functional protective treatments for wood that will prevent tannin-staining, and will provide surface protection, as well as “in depth” protection against destructive biological factors, including termites. Such a multi-functional treatment has not been developed prior to the present application and would be advantageous. Thus, it is considered useful and progressive to develop aqueous “in depth” protective formulations and treatments that will further protect wood substrates against mildew, fungi, algae, bacteria and, specifically, against termites, as well as against tannin staining.

### SUMMARY OF THE INVENTION

Pursuant to the present invention, the above-described concepts (see the cited US Patents, above) and practices have been significantly extended for protection of wood against destructive biological agents. It has been discovered that stable and effective multi-functional formulations are obtainable by addition of diverse selected (guest) cationic species and/or diverse bio-active organic compounds, or mixtures thereof, into aqueous solution of selected zirconyl salts, which includes zirconyl acetate among others. It has been also discovered that aqueous solutions of zirconyl salts modified by addition of mixtures of bio-active compounds display remarkable ability to absorb into wood. That is, in general, aqueous solutions of zirconyl salts function not only as effective carrier mediums for biocides intended for wood protection, but the zirconyl salts also act as functional mediums (i.e. stain inhibitor). Further more, upon evaporation of the aqueous part of the formulation during the drying stage, absorbed zirconyl species precipitate into pores of wood and react with and crosslink with the wood cellulose. Consequently, it appears that the process yields “in situ” immobilization of both, the biocide constituents of the treatment and of the indigenous soluble tannin species responsible for staining. In contrast with commercial solvent borne treatments, it will be also noted that the aqueous protective treatments according to the present invention, preserve the natural color, texture and the desired hydrophil character of wood substrates, which remain suitable for subsequent aqueous coating applications.

Further, it has been learned pursuant to the present invention that as the cumulative result of chemical composition and of inherent properties, the discovered formulations act as effective and multi-functional aqueous protective treatments for wood. These aqueous formulations provide both, surface and “in depth” protective functions, such as broad spectrum protection of wood substrates against mildew, fungi, bacteria, algae and most notably, against termites, as well as against tannin staining of wood coatings.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific contexts. While the preferred embodiment has been described, the details may be changed without departing from the invention.

Preparation of aqueous (carrier) solutions of various soluble zirconyl salts, and of solutions modified by diverse guest cationic species can be carried out following procedures known to the art or, respectively, as described in U.S. Pat. Nos. 5,759,705 and 5,733,666, herein incorporated by reference. With no intent to limit the list of possible water soluble salts useful as carrier solutions, example of applicable zirconyl salts include acetates, nitrates, chlorides, sulfates, mixtures thereof, as well as zirconium ammonium carbonate, zirconium potassium carbonate and zirconium sodium carbonate.

Selected (guest) cationic species, applicable as additives with the intent to modify the chemical composition of aqueous solutions of zirconyl salts, in accordance with the present invention, include: Hf(IV), Cu(II), Zn(II), Ce(III), Ce(IV), Ti(IV), Sn(II,IV)), Sb(III), Bi(III), Al(III), and/or organic quaternary ammonium compounds and mixtures thereof.

It will be noted in this regards that some rare earth species, such as Ce(III), are generally credited with the ability to absorb, and consequently to protect (substrates) against harmful UV radiations. Also, Cu(II), Zn(II) and some quaternary ammonium compounds are known for their anti-bacterial and/or anti-fungal activity.

Preparation of aqueous multi-functional protective treatments for wood and wood substrates according to the present invention are realized by addition of selected bio-active compounds or mixtures thereof, to the carrier solution of an aqueous zirconyl salt or carrier solution modified by guest cationic species.

It is understood that, in this context, bioactive compounds can be defined as organic or inorganic compounds possessing (selective or broad) toxic capacity against, for example, termites, fungi, mildew, mold, algae, yeast, or combinations thereof, the bio-factors which cause degradation of wood.

Likewise, bio-environmental degradation should be considered as degradation or deterioration of wood substrate caused by the above specified bio-factors and, also, by such physical environmental factors as UV radiation, seasonal temperature variations, air humidity, condensation, and swelling/shrinking (dimensional instability) of wood.

It is well known that the commercial usage of biocides is strictly regulated in the industry. Consequently, a relatively limited number of registered bioactive compounds constitute the active ingredients of a large arsenal of commercial biocide formulations marketed for protection of various water-based industrial products, such as adhesives, paints, construction materials, detergents, metalworking fluids, pulp, paper processing, textiles, wood and protective coating applications on wood.

Some of the most widely used bio-active compounds, applicable also for surface protection of wood, include:
3-Iodo-2-Propynyl-Butyl-carbamate, or IPBC, a broad spectrum fungicide, effective against mold, mildew, algae, moderately soluble in water;
1,2-Benzisothiazoline-3-One, or BIT, a water soluble wide spectrum biocide, effective against bacteria, yeast and fungi;
5-Hydroxymethyl-1-aza-3,7-dioxabicyclo(3,3,0)octane, bactericide;
   1-(3-chloroallyl)-3,5,7-triaza-1-azoniaadamantane chloride, a bactericide, compatible with water;
   Methyl(1H-benzimidazole-2-yl)carbamate, or Carbendazim, a fungicide, essentially insoluble in water;
   3-(3,4-Dichlorophenyl)-1,1-dimethylurea, or Diuron, a herbicide, slightly soluble in water;
4,5-Di-Chlor-2-N-Octyl-4-Isothiazolin-3-One, or DCOIT, fungicide;
   cis-trans-1-[2-(2,4-dichlorophenyl)-4-propyl-1,3-dioxolan-2-ylmethyl]-1H-1,2,4-triazole, or Propiconazole, fungicide;
   5-chloro-2-methyl-4-isothiazoline-3-one, or CMIT, a broad spectrum antimicrobial;
   2-methyl-4-isothiazolin-3-one, or MIT, a broad spectrum biocide;
2-[(Hydroxymethyl)amino]ethanole, a water soluble bactericide;
4,4-Dimethyl-1,3-oxazolidine, a water soluble bactericide;
N-methyl-2-hydroxymethyleneoxypropyl-2′-hydroxypropylamine, a water soluble bactericide;
Fatty alkyl amine (capryryl, lauryl, palmythyl, stearyl) hydrochlorides, microbicides, soluble in water;
Tetrahydro-3,5-dimethyl-2H-1,3,5-thiadiazine-2-thione, a broad spectrum bactericide of limited solubility in water;
Parachlorometacresol, a bactericide, with limited solubility in water;
N-(Trichloromethylthio)phthalimide, a bactericide, fungicide, practically insoluble in water;
Tributyltin benzoate, an effective microbicide, fungicide, mildewcide, insoluble in water;
Tetrachloroisophthalonitrile, a fungicide, mildewcide, with limited solubility in water;
N-Cyclopropyl-N′-(1,1-dimethylethyl)-6-(methylthio)-1,3,5-triazine-2,4-diamine, an algaecide, practically insoluble in water;

Some of the termicides widely used in commercial products intended for “in depth” protection of wood, are as follow:
1-((6-cloro-3-pyridinyl)methyl)-N-nitro-2-imidazolodinimine, practically insoluble in water;
(R,S)-alpha-cyano-3-phenoxybenzyl(1RS)-cis,trans-3-(2,2-dichlorovinyl)-2,2-dimethylcyclopropane-carboxylate, or Cypermethrin, practically insoluble in water;
3-phenoxybenzyl(1RS)-cis, trans-3-(2,2-dichlorovinyl)-2,2-dimethylcyclopropane-carboxylate, or Permethrin, also practically insoluble in water;
O,O-diethyl-O-3,5,6-trichloro-2-pyridyl phosphorothiolate, or Chloropyrifos, with limited solubility in water;
2-methylbiphenyl-3-ylmethyl-(Z)-(1RS)-cis-3-(2-chloro-3,3,3-trifluoroprop-1-enyl)-2,2-dimethylcyclopropanecarboxylate, or Bifentrin;

Most commercial biocide formulations, which can be water- or solvent-soluble or compatible, usually contain a synergistic “cocktail” of bio-active compounds and are formulated to provide broad spectrum antimicrobial protection, such as against bacteria, fungi, mildew, mold, algae, yeast, for the above specified wide range of water-based industrial products, inclusive wood coatings.

Some of the widely recognized trade names of such commercial products are: Polyphase (Troy Chemical Corp.), Nuosept and Fungitrol (International Specialty Products), Omacide (Arch Chemicals), Busan (Buckman Laboratories, Inc.), Rocima (Rohm & Haas) and Dowicil (Dow Chemical Co.)

Preparation of aqueous multi-functional protective treatments for wood and wood substrates according to the present invention is realized by incorporating (depending on their physical properties, by dissolution, or in dispersed or emulsified form) selected bio-active constituents or mixtures thereof, into the carrier solution of an aqueous zirconyl salt or carrier solution modified by guest cationic species.

It will be apparent however, that alternatively, selected commercial bio-active formulations, or mixtures thereof can be also most conveniently incorporated into the aqueous carrier solutions according to the present invention.

In order to increase the absorption rate into the wood and/or to stabilize heterogeneous formulations, limited but effective amounts of soluble, surface-active, auxiliary additives, preferably quaternary ammonium salts, or either non-ionic or amphoteric types, can be added to the aqueous formulations according to the present invention. With the intent to prevent foaming during application, defoamers may also be included.

It will be apparent that the object of this invention is relevant to various segments of the wood processing industry, in general.

It is estimated, however, that the application of the present invention would be most beneficial where the service conditions of wood mandate both, surface protection (intended to conserve aesthetic value by inhibiting spontaneous staining of applied coatings and/or against surface acting destructive factors such as mildew or fungus) as well as “in depth” protection against destructive bio-factors such as termites. “In-depth”, in this context, refers to the (below the surface) whole inner mass of wood substrates.

The zirconyl compound acts as the carrier for the biocide and transports the biocide in-depth into the wood substrate. Upon evaporation of the aqueous part of the multi-functional treatment, absorbed zirconyl species precipitate into pores of the wood or wood substrate and react with and cross-link with the wood cellulose. As a result, the zirconyl compound not only inhibits spontaneous staining of coatings on the wood substrate, but, also, immobilizes the biocide in situ within the wood substrate, which further enhances the ability of the biocide to protect the wood in-depth, especially against termites. This is done while protecting the natural color, texture, and the desired hydrophil character of the wood or wood substrate.

The following market segments of the wood processing industry are specifically considered:
Manufacturing of wood windows and doors, flooring and cabinetry;
Manufacturing of wood material for: wood siding, landscaping ties, fence post, building and utility poles, piling, decking, wood shingles and log homes;
Manufacturing of: waferboard, fiberboard, particleboard, plywood, oriented-strand board, pre-coated lumber and millwork;

Furthermore, it will be noted that the protective treatments according to the present invention are applicable not only for above ground but also for below ground protection of wood material against destructive bio-factors such as termites.

It will be also apparent that, essentially, any wood species is suitable for treatment according to the disclosure of the present inventions. Some of the commercially available most popular treatable wood species are: cedar, redwood, oak, pine, fir, and mahogany. Wood composites are also treatable, (which essentially consist of wood granules bound together, usually by thermoset resinous components) inclusive board varieties as above specified. It should be understood that the present invention is applicable to all wood surfaces, substrates, and wood composites. Unless specified, references to wood or wood substrates, in general, include any different wood species or structures described herein.

Any method known to the art, or used traditionally by the industry to apply liquid treatments on wood substrates, is also applicable in the context of the present invention. Examples of such application methods are presented, as follows:

Air spray, or airless spray, vacuum coater, curtain coater, roll coat, flow coat, by immersion, by sponge, brush, or roller.

Immersion is, however, the preferred application process according to the present invention. Application by immersion of the aqueous treatments according to the present invention may be performed in an open or closed system, and, also, at normal or elevated temperature.

After application of an aqueous treatment, drying of the treated substrates can be performed either at ambient temperature for an appropriate length of time, or in forced conditions at an elevated temperature. It will be apparent that at an elevated temperature, a complete absorption of the aqueous treatment application into the wood substrate must be realized before the operation of drying the substrate begins.

As a final step of application, an organic primer may be used as an overcoat for the treated wood substrates according to the present invention.

With no intent to limit the concept or practice of the present invention, the following Comparative Examples and Examples disclose some preferred practices and procedures.

### COMPARATIVE EXAMPLE #1

An aqueous solution of zirconyl acetate, one of the applicable zirconyl compounds preferred according to the present invention, was prepared accordingly as known in the art.

100.0 g of aqueous zirconyl carbonate paste, commercially available with an assay of approximately 39-40% ZrO₂, was reslurried in 150 ml water. Subsequently the slurry was reacted with 39.0 g of glacial acetic acid at ambient temperature and agitated, in approximately a 1:2 stoichiometrical ratio.

The reaction was finalized by keeping the obtained solution at about 60° C. for approximately (2) two hours. Approximately 190 g of clear solution resulted, with the solution characterized by a pH ˜4.0, and containing an assay (determined gravimetrically by ignition at approximately 600° C.) of 21.0% ZrO₂ by weight.

### COMPARATIVE EXAMPLE #2

An aqueous solution of zirconyl acetate modified by Ce(III) (guest) species, containing Ce(III) and acetic acid in molar ratios of approximately n(Zr):n(Ce)=4:1 and n(acetic acid):[n(Ce)+n(Zr)]=1.7:1, respectively, was produced pursuant to the following procedure.

Initially, an aqueous mixed suspension was prepared by dispersing 166.0 g of wet zirconyl carbonate (see Comparative Example #1) and 36.0 g of Ce₂(CO₃)₃.(H₂O)₃ (a commercially available product, having an assay of 49.5% CeO₂) in 160.0 ml water. The mixed suspension was subsequently solubilized by gradual introduction of 72.0 g of glacial acetic acid and agitated extensively at 40-45° C. The process was completed by maintaining the conditions constant for about 4 (four) hours. Approximately 400 g of a clear and slightly yellow solution resulted, which was characterized by the following quality parameter values: assay (by ignition at 600° C.), as (ZrO₂+CeO₂)=21%; pH=3.5-4.0; specific gravity=1.24. The yield was approximately 400 g.

It will be apparent that Ce(III) can be replaced by a comparable amount of Ce(IV). Also, it will be noted that, alternatively, Ce-carbonate can be substituted for other lanthanides or mixed-lanthanide (Ln) compounds, such as La-Carbonate or Ln-Carbonates, respectively.

### COMPARATIVE EXAMPLE #3

An aqueous solution of zirconyl acetate, modified by the addition of a Cu(II) species, containing Cu(II) and acetic acid in molar ratios of approximately n(Zr):n(Cu)=9:1 and n(acetic acid):[n(Zr)+n(Cu)]=1.6:1, respectively, was produced essentially according to the procedure presented in Comparative Example #2. In this case, however, 192.0 g of wet zirconyl carbonate (see Comparative Example #1), 10.0 g of commercially available Cu(BO₂)₂ (Cu(II)-borate), or, alternatively, 3.5 g Cu(OOC—CH₃)₂.H₂O (Cu(II)-acetate), was dispersed in 150 ml water and dissolved in 68.0 g glacial acetic acid. The resultant product was a clear, moderately blue solution, characterized by the following quality parameter values: assay (by ignition at 600° C.) of about 20%, as (ZrO₂+CuO); pH=3-4; and a specific gravity=1.23 at 24° C. The yield was approximately 400 g.

### COMPARATIVE EXAMPLE #4

An aqueous solution of zirconyl acetate was modified by addition of an organic cationic species, such as typical for quaternary ammonium salts. In that purpose 1.77 g of 1-(3-chloroallyl)-3,5,7-triaza-1-azoniaadamantane chloride, as an aqueous solution of 5.0% (available from The Dow Chemical Co. under the trade name of Dowicil 75 Preservative, containing 67.5% of active ingredient) was gradually introduced by agitation into 400.0 g of zirconyl acetate solution obtained according to Comparative Example #1. The preparation process was finalized by agitation until a clear solution of similar quality as described in Comparative Example #1, was obtained. The quaternary ammonium salt content of the final product was calculated at approximately 0.3%.

### COMPARATIVE EXAMPLE #5

A white pigmented paint formulation, typically used for wood protection and applied in context of the present invention, is presented below. It will be observed that the formulation contains commercially available tannin staining inhibitive pigment.

| Components of | Trade Names | Parts by |
|---|---|---|
| Formulation | (Supplier) | Weight |
| H₂O | — | 203.0 |
| TiO₂ | RCL-535 (1) | 150.0 |
| Filler pigment | Gammaspers 80 (2) | 116.0 |
| Stain Inhibitor | * | 33.0 |
| Pigment | | |
| Coalescent solvent | Ethylene glycol | 5.0 |
| | Texanol (3) | |
| Freeze | Surfonyl 104 A | 2.0 |
| stabilizer/coalescent | (4) | |
| stabilizer | | |
| Thickener | Acrysol (5) | 5.5 |
| | Natrosol (6) | 0.5 |
| Dispersant | Tamol 681 (5) | 12.0 |
| Biocide | Skane M-8 (5) | 2.0 |
| Neutralizer | Ammonia, 28% | 1.0 |
| Latex resin | Maincote MV-23LO | 520.0 |
| | (5) | |
| Total | | 1069.0 |

Suppliers of components are:
(1) SCM Chemicals;
(2) Georgia Marble Co.;
(3) Eastman Chemical Co.;
(4) Air Products and Chemicals;
(5) Rohm and Haas Co.;
(7) Aqualon.
* Commercially available stain inhibitor pigment.

### EXAMPLES

The following examples are used to demonstrate the utility of the present invention.

### Example #1

An aqueous treatment for wood, possessing dual protective anti-fungal and stain inhibiting functions was prepared by the addition of 3.0 g of Troysan Polyphase WD-17 (a broad spectrum biocide commercially available from Troy Chemical Corp.) into 97.0 g of zirconyl acetate solution prepared according to Comparative Example #1. This mixture was stirred for one (1) hour and the resulted formulation of aqueous treatment was characterized, as follows:
Appearance Opalescent liquid
Specific gravity 1.28
pH ˜4
ZrO₂, % calculated 21.3
H₂O, % calculated ˜60

### Example #2

An aqueous treatment possessing broad spectrum anti-fungal and stain inhibitor protective function for wood was prepared by addition of 3.0 g Troysan Polyphase WD-17 and 1.0 g of Dowicil 75 Preservative (see also Comparative Example #4) into 95.5 g of zirconyl acetate solution produced according to comparative Example #1. The preparation process was finalized by extensive stirring and the resulted product was characterized as follows:

| Appearance | Opalescent liquid |
|---|---|
| Specific gravity | 1.29 |
| pH | 3.7-4 |
| ZrO₂, % calculated | 20 |
| Total Biocide, % calculated | ˜2.0 |
| H₂O, % calculated | ˜59 |

### Example #3

An aqueous treatment, possessing a ternary protective function (against tannin staining, fungus and/or mildew, and termites) for wood substrates, was prepared by the addition of 50.0 g water, 0.5 g of 3-Iodo-2-Propynyl-Butyl-carbamate, or IPBC, a moderately soluble broad spectrum fungicide, effective against mold, mildew. and 0.05 g 1-((6-cloro-3-pyridinyl)methyl)-N-nitro-2-imidazolodinimine, a termicide, practically insoluble in water, into 50.0 g of zirconyl acetate solution obtained according to Comparative Example #1.

This mixture was stirred for one (1) hour and the resultant formulation of aqueous treatment was characterized as follows:

| Appearance | Opalescent liquid |
|---|---|
| Specific gravity | 1.10-1.11 |
| pH | 3.5-3.8 |
| ZrO₂, % calculated | 10.5 |
| Total Biocide, % calculated | ˜0.55 |
| H₂O, % calculated | 79 |

### Example #4

An aqueous treatment possessing a ternary protective function for wood was prepared in similar fashion as disclosed in Example #3, except that 50.0 g of Ce(III)-modified Zirconyl acetate solution, according to Comparative Example #2, was used as a carrier.

This formulation was characterized as follows:

| Appearance | Opalescent liquid |
|---|---|
| Specific gravity | 1.10-1.11 |
| pH | 3.5-3.8 |
| ZrO₂ + CeO₂, % calculated | 10.5 |
| Biocide, % calculated | ˜0.55 |
| H₂O, % calculated | 79 |

### Example #5

In order to qualify the tannin stain inhibitor efficiency of the aqueous treatment according to Example #1, the treatment was applied on a one-half section (test) of a surface finished Redwood panel (about 20 inch², each section), by brush at an approximate spread rate of 0.1 g/inch², after which the panel was kept overnight at ambient temperature.

Subsequently, paint formulation according to Comparative Example #5 was applied by a 3-mil letdown bar on both the treated (test) and untreated (control) section of the panel, after which the panel was allowed to dry overnight at ambient temperature.

In order to assess the tannin stain inhibitor efficiency of the aqueous treatment, the initial color value (dEᵢ) was measured versus the test and control coating applications, which was prepared on a non-staining surface (laminated white paper card, King James CLS Cover type), which is considered as the color standard. Consecutively, the panel was exposed to condensing humidity conditions, continuously, for 10 (ten) days, after which the extent of discoloration occurred (dE_{f}) was assessed again in identical fashion, by measuring the related color values, comparatively to the same color standard.

The extent of discoloration due to staining, dE, which can be stated as inversely proportional with the extent of stain inhibition (if applicable), was obtained by dE=dE_{f}−dEᵢ, for both the control (dE_{c}) and test (dEₜ) sections. The experimental results are presented below:

| Discoloration | | |
|---|---|---|
| Values | Test | Control |
| dEᵢ | 1.5 | 4.8 |
| DE_{f} | 2.8 | 18.1 |
| DEₜ | 1.3 | — |
| DE_{c} | — | 13.3 |

The stain inhibitor efficiency (I) of the aqueous treatment according to Example #1, was calculated by: I=(dE_{c}−dEₜ)/dEₜ=9.2. It will be apparent that the large value of I=9.2 is an indicator of high efficiency in tannin stain inhibition.

### Example #6

A ternary protective formulation, as described in Example #3, was used to demonstrate practical “in bulk” protective efficiency for specific aqueous treatments produced according to the present invention. The treatments were tested for their efficiency against biologically destructive agents of the wood substrates, namely fungi and termites.

A significant number of test wood blocks, pine of 1″×1″×1″ (for WDMA TK-1 test, see Example #7), and, respectively, pine of ⅛″×1″×1 9/16″ dimensions (for AWPA E-97 test, see Example #8) were prepared as follows: immersion of the test wood block for 15-30 seconds, followed by drying for 4-8 hours at ambient temperature. Alternatively, after immersion, a 2-5 minutes absorption time was allowed, followed by force drying at 49° C.-60° C.(120-140° F.), for 30-45 minutes.

The test blocks cover prescribed, standardized test procedures for wood block size and wood species.

The prepared test wood blocks were used in specific test procedures as described in Example #7 (test for evaluation of protective effectiveness against fungi) and Example #8 (test for evaluation of protective efficiency against termites).

### Example #7

The protective efficiency of the aqueous treatment, prepared according to Example #3, against fungal attack of a wood substrate, was assessed following the specific test procedure WDMA TK-1 Soil Block Test, “Test Method to Determine Preservative Effectiveness in Preventing Wood Decay”.

The test results obtained on the 1″×1″×1″ pine wood blocks are presented below:

Average Weight
Loss, %

| Number of blocks | Brown Rot | White Rot |
|---|---|---|
| 6 (Control, | 66.1 | 28.2 |
| Unprotected) | | |
| 6 (Test) | 0.0 | 0.0 |

The experimental results indicate high degree of fungal protection against both brown rot and white rot of the aqueous treatment prepared according to Example #3 of the present invention.

### Example #8

The “in depth” protective function of the aqueous treatment, prepared according to Example #3, against termites (Reticulotermes Flavipes) was assessed following the specific test procedure AWPA E-97, “Standard Method for Laboratory Evaluation to Determine Resistance to Subterranean Termites”.

The test results obtained on pine wood blocks of ⅛″×1″×1 9/16″ are presented below:

| Number of Wood Blocks | Average Weight Loss, % |
|---|---|
| 12 (Control, Unprotected) | 54.0 |
| 6 (Test) | 1.5 |

The experimental results indicate a high degree of protection against termites for the aqueous treatment according to Example #3 of the present invention.

Thus, the present invention provides a new, novel (multi-functional, broad spectrum) aqueous protective treatment for wood substrates, effective not only against surface-active destructive bio-factors such as mildew, fungi, bacteria, algae, but also against spontaneous staining of protective coatings on wood, and most notably, also against “in depth” acting termites.

It is estimated that the present invention would be most beneficial where the service conditions of wood mandate both, surface protection and “in depth” protection, as above specified.

The foregoing is considered as illustrative only of the principles of the invention. Furthermore, since numerous modifications and changes will readily occur to those skilled in the art, it is not desired to limit the invention to the exact compositions and operations shown and described. While the preferred embodiment has been described, the details may be changed without departing from the concepts of this invention.

We claim:

1. A process for treating a wood substrate to concurrently inhibit staining by said wood substrate, bio-environmental surface degradation of said wood substrate, and for in-depth protection against termites for said wood substrate, said process comprising:
providing an aqueous treatment solution comprising:
a bio-active constituent; and
a zirconyl salt, said zirconyl salt acting as a carrier for said bio-active constituent;
applying said solution to said wood substrate;
absorbing said solution into said wood substrate;
and
drying said absorbed solution, whereby bio-environmental degradation of said wood substrate, staining by said wood substrate, and in depth degradation caused by termites is inhibited.

2. The process according to claim 1 further comprising the step of applying a coating to said wood substrate after the step of drying said solution.

3. The process according to claim 2 wherein said coating comprises an organic coating.

4. The process according to claim 1 wherein said step of applying comprises immersing said wood substrate in said aqueous solution.

5. The process according to claim 1 wherein said step of absorbing further comprises transporting said biocide with said zirconyl salt in depth into said wood substrate.

6. The process according to claim 5 wherein said step of drying said solution further comprises immobilizing said biocide in situ of said wood substrate.

7. A solution for preventing bio-environmental degradation of a wood substrate, said solution comprising:
an aqueous carrier solution comprising a zirconyl salt; and
a bio-active constituent.

8. The solution according to claim 7, wherein the zirconyl salt is selected from the group consisting of: acetates, nitrates, chlorides, sulfates, zirconium ammonium carbonate, zirconium potassium carbonate, and combinations thereof.

9. The solution according to claim 8 further comprising a guest cationic species.

10. The solution according to claim 9, wherein said guest cationic species is selected from the group consisting of: Hf(IV), Cu(II), Zn(II), Ce(III), Ce(IV), Ti(IV), Sn(II,IV)), Sb(III), Bi(III), Al(III), and organic quaternary ammonium compounds and mixtures thereof.

11. The solution according to claim 7, wherein said bio-active constituent is selected from the group consisting of: 3-Iodo-2-Propynyl-Butyl-carbamate; 1,2-Benzisothiazoline-3-One; 5-Hydroxymethyl-1-aza-3,7-dioxabicyclo(3,3,0)octane; 1-(3-chloroallyl)-3,5,7-triaza-1-azoniaadamantane chloride; Methyl(1H-benzimidazole-2-yl)carbamate; 3-(3,4-Dichlorophenyl)-1,1-dimethylurea; 4,5-Di-Chlor-2-N-Octyl-4-Isothiazolin-3-One; cis-trans-1-[2-(2,4-dichlorophenyl)-4-propyl-1,3-dioxolan-2-ylmethyl]-1H-1,2,4-triazole; 5-chloro-2-methyl-4-isothiazoline-3-one; 2-methyl-4-isothiazolin-3-one; 2-[(Hydroxymethyl)amino]ethanole; 4,4-Dimethyl-1,3-oxazolidine; N-methyl-2-hydroxymethyleneoxypropyl-2′-hydroxypropylamine; Fatty alkyl amine (capryryl, lauryl, palmythyl, stearyl); Tetrahydro-3,5-dimethyl-2H-1,3,5-thiadiazine-2-thione; Parachlorometacresol; N-(Trichloromethylthio)phthalimide; Tributyltin benzoate; Tetrachloroisophthalonitrile; N-Cyclopropyl-N′-(1,1-dimethylethyl)-6-(methylthio)-1,3,5-triazine-2,4-diamine; 1-((6-cloro-3-pyridinyl)methyl)-N-nitro-2 imidazolodinimine; (R,S) -alpha-cyano-3-phenoxybenzyl(1RS) -cis,trans-3-(2,2-dichlorovinyl)-2,2-dimethylcyclopropane-carboxylate; 3-phenoxybenzyl(1RS)-cis,trans-3-(2,2-dichlorovinyl)-2,2-dimethylcyclopropane-carboxylate; O,O-diethyl-O-3,5,6-trichloro-2-pyridyl phosphorothiolate; 2-methylbiphenyl-3-ylmethyl-(Z)-(1RS)-cis-3-(2-chloro 3,3,3-trifluoroprop-1-enyl)-2,2 dimethylcyclopropanecarboxylate, and combinations thereof.

12. The solution according to claim 7 further comprising an additive for stabilizing the solution.

13. The solution according to claim 12 wherein said additive comprises a quaternary ammonium salt.

14. A multi-functional aqueous treatment for the protection of a wood substrate, said aqueous treatment comprising:
a first zirconyl compound to inhibit spontaneous tannin staining of organic coatings applied on the surface of said wood substrate; and
a second organic constituent to inhibit bio-degradation on the surface of said substrate and bio-environmental damage to said wood substrate.

15. The aqueous treatment according to claim 14 wherein said zirconyl compound comprises a zirconyl salt.

16. The aqueous treatment according to claim 15 wherein said second organic constituent is selected from the group consisting of: 3-Iodo-2-Propynyl-Butyl-carbamate; 1,2-Benzisothiazoline-3-One; 5-Hydroxymethyl-1-aza-3,7-dioxabicyclo(3,3,0)octane; 1-(3-chloroallyl)-5,7-triaza-1-azoniaadamantane chloride; Methyl(1H-benzimidazole-2-yl)carbamate; 3-(3,4-Dichlorophenyl)-1,1-dimethylurea; 4,5-Di-Chlor-2-N-Octyl-4-Isothiazolin-3-One; cis-trans-1-[2-(2,4-dichlorophenyl)-4-propyl-1,3-dioxolan-2-ylmethyl]-1H-1,2,4-triazole; 5-chloro-2-methyl-4-isothiazoline-3-one; 2-methyl-4-isothiazolin-3-one; 2-[(Hydroxymethyl)amino]ethanole; 4,4-Dimethyl-1,3-oxazolidine; N-methyl-2-hydroxymethyleneoxypropyl-2′-hydroxypropylamine; Fatty alkyl amine (capryryl, lauryl, palmythyl, stearyl); Tetrahydro-3,5-dimethyl-2H-1,3,5-thiadiazine-2-thione; Parachlorometacresol; N-(Trichloromethylthio)phthalimide; Tributyltin benzoate; Tetrachloroisophthalonitrile; N-Cyclopropyl-N′-(1,1-dimethylethyl)-6-(methylthio)-1,3,5-triazine-2,4-diamine; 1-((6-cloro-3-pyridinyl)methyl)-N-nitro-2 imidazolodinimine;(R,S)-alpha-cyano-3-phenoxybenzyl(1RS)-cis,trans-3-(2,2-dichlorovinyl)-2,2-dimethylcyclopropane-carboxylate; 3-phenoxybenzyl(1RS)-cis,trans-3-(2,2-dichlorovinyl)-2,2-dimethylcyclopropane-carboxylate; O,O-diethyl-O-3,5,6-trichloro-2-pyridyl phosphorothiolate; 2-methylbiphenyl-3-ylmethyl-(Z)-(1RS)-cis-3-(2-chloro 3,3,3-trifluoroprop-1-enyl)-2,2 dimethylcyclopropanecarboxylate, and combinations thereof.

17. The aqueous treatment according to claim 16, wherein the zirconyl salt is selected from the group consisting of: acetates, nitrates, chlorides, sulfates, zirconium ammonium carbonate, zirconium potassium carbonate, and combinations thereof.

18. The aqueous treatment according to claim 17 further comprising a guest cationic species.

19. The aqueous treatment according to claim 18, wherein said cationic species is selected from the group consisting of: Hf(IV), Cu(II), Zn(II), Ce(III), Ce(IV), Ti(IV), Sn(II,IV)), Sb(III), Bi(III), Al(III), and organic quaternary ammonium compounds and mixtures thereof.

20. The aqueous treatment according to claim 19 further comprising an additive for stabilizing the solution.

21. A process for treating a wood substrate to concurrently inhibit staining by said wood substrate, said process comprising:
providing an aqueous treatment solution comprising:
an aqueous carrier solution comprising a zirconyl salt,
applying said treatment solution on said wood substrate, wherein said carrier solution inhibits tannin staining by said wood substrate, when said treatment solution is applied upon said wood substrate.

22. The process according to claim 21 wherein said zirconyl salt is selected from the group consisting of: acetates, nitrates, chlorides, sulfates, zirconium ammonium carbonate, zirconium potassium carbonate and combinations thereof.

23. The process according to claim 21 wherein said aqueous treatment further comprises a bio-active constituent, said bioactive constituent protecting said wood substrate against bio-environmental degradation caused by at least one of the following environmental factors: fungi, mildew, algae, bacteria and termites.
